(19) United States
(12) Patent Application Publication
(10) Pub. No.: US 2007/0257194 A1
(43) Pub. Date: Nov. 8, 2007

(54) Terahertz heterodyne tomographic imaging system

(76) Inventor: Eric R. Mueller, West Suffield, CT (US)

Correspondence Address: STALLMAN & POLLOCK LLP, 353 SACRAMENTO STREET, SUITE 2200, SAN FRANCISCO, CA, 94111, US

(21) Appl. No.: 11/811,045

(22) Filed: Jun. 8, 2007

Related U.S. Application Data
(63) Continuation-in-part of application No. 11/085,859, filed on Mar. 22, 2005.
(63) Continuation-in-part of application No. 11/231,079, filed on Sep. 20, 2005.
(60) Provisional application No. 60/814,771, filed on Jun. 19, 2006.

(51) Int. Cl. G01J 5/02

(52) U.S. Cl. 250/341.8; 250/338.1

(57) ABSTRACT

A method of forming a three-dimensional internal image of an object includes illuminating the object with terahertz (THz) radiation and detecting THz radiation that is either transmitted through, reflected from or backscattered from the object. The detected radiation is used to form a series of two-dimensional images of the object at different angles or positions. The recorded two-dimensional images are electronically processed using computer aided tomography (CAT) algorithms to form the three-dimensional image of the object.

### PRIORITY

This application is a continuation-in-part of U.S. patent application Ser. No. 11/085,859, filed Mar. 22, 2005, and is also a continuation-in-part of U.S. patent application Ser. No. 11/231,079, filed Sep. 20, 2005. This application claims priority to U.S. Provisional Application Ser. No. 60/814,771, filed Jun. 19, 2006, the disclosure of which is incorporated by reference.

### TECHNICAL FIELD OF THE INVENTION

The present invention relates in general to terahertz (THz) or submillimeter imaging systems. The invention relates in particular to THz imaging systems using heterodyne detection to generate three dimensional images of the interior of an object.

### DISCUSSION OF BACKGROUND ART

The terahertz frequency range is a relatively underdeveloped band of the electromagnetic spectrum. The terahertz band is bordered by the infrared on the short-wavelength side and millimeter-waves on the long-wave length side. The terahertz band encompasses radiation having a frequency range of 0.3 to 10 THz and wavelengths between about 30 micrometers (μm) and 1 millimeter (mm). The terahertz band is sometimes referred to by practitioners of the art as the far infrared (FIR) or as sub-millimeter waves.

Many materials that are opaque to wavelengths shorter then 30 micrometers are either transparent or semi-transparent in the terahertz region. Such materials include plastic, textiles, paper, cardboard, wood, ceramics, opaque glasses, semiconductors, and the like. Radiation at longer wavelengths, for example, millimeter waves have better transmissivity than terahertz radiation in these materials but the longer wavelengths are unsuitable for use in high resolution imaging systems because of their longer wavelengths. Further, such materials do not have much spectral content, i.e., characteristic absorption lines, in these longer wavelength regions that would allow one material to be easily distinguished from another.

Terahertz radiation is not an ionizing radiation, so it does not have the potential to damage biological tissues as would, for example, X-radiation (X-Rays). Terahertz radiation can be propagated for much longer distances in the atmosphere than X-rays, for example, several meters, and does not cause damage to electronic devices and unexposed film. In addition to offering a higher potential resolution in imaging than millimeter waves, terahertz radiation also offers a potential to provide sharper differentiation between different materials superimposed on one another and, accordingly provide higher contrast images than would be possible with millimeter waves.

Based on these advantages, researchers have explored the application of THz radiation in direct detection laser systems to probe and image the inside of plastic, textiles, paper cardboard, wood, ceramic, opaque glasses, etc. packages and packaged semiconductor chips. Direct detection THz laser radiation systems have also been used to detect compositions of gas, drugs, and biological agents, and the like. Astronomers have developed THz heterodyne detection systems for earth, planetary, and space science applications. The biological and biomedical researchers have also begun to pursue THz technology.

The following patent references illustrates some of the applications of THz radiation utilizing direct detection and time domain systems, each of which is incorporated herein by reference.: U.S. Pat. No. 6,525,862; and U.S. Patent Application Publication Nos. 2004/0065831 and 2003/0178584.

Researchers have also started to explore the 3-dimensional imaging potential of THz radiation using direct detection THz laser systems coupled with well known computer aided tomography (CAT) techniques extensively utilized in 3-D x-ray medical imaging systems. Such systems are also being considered for homeland security applications, for examining the interior of luggage or packages, or examining the interior defects in plastic, wood, ceramic, etc. packages or structural materials. The following references provide examples of such time domain and direct detection THz 3-D imaging applications and implementation approaches each of which is incorporated herein by reference:

Pulsed Terahertz Tomography by S. Wang and X-C. Zhang; Journal of Physics D: Applied Physics 37 (2004) R1-R36.

Three-Dimensional Terahertz Wave Imaging by X-C. Zhang; Phil. Trans. Royal Society of London A(2004) 362 PPS. 283-299.

Three-Dimensional Imaging With A Terahertz Quantum Cascade Laser; Optics Express (20 Mar. 2006), Vol. 14, No. 6 PPS 2123-2129.

In many industrial, scientific research, or medical applications, it is necessary to determine the distribution of some physical property (e.g., density, absorption, scattering, etc. variations) internal to the object/sample under investigation. The value of strip integrals of such a distribution within the object/sample can, in certain cases, be deduced from appropriate physical measurements and the set of line strip integrals corresponding to a particular angle of view known as a projection of the object. Obtaining a number of such projections at different angles of view, an estimation of the corresponding distribution within the object can be obtained. By the practitioners of the art, this process is called image reconstruction from projections. Computed x-ray tomography is undoubtedly the most significant application to-date of image reconstruction from projections.

In computed x-ray tomography, an x-ray beam is passed through the portion of a person or object which is to be imaged. The amount of the beam that is transmitted is detected and the data stored in memory. The x-ray beam is rotated 180 degrees so a set of data on the amount of x-rays transmitted along strips of the object as a function of angle is obtained and stored. The beam is then moved to an adjacent location and the process repeated until the object has been completely irradiated and all the data as a function of angle and lateral displacement is stored. All the collected strip data is then processed by the appropriate software reconstruction algorithms that are now well known to those experienced in the state of the art of computed aided tomography (CAT). In this lay-man explanation of the CAT process, the x-ray beam transmission was used as an example, but the process can also work by detecting, storing, and then processing the transmitted or the back scattered radiation throughout the electromagnetic spectrum as a function of angle and lateral movement of the beam of radiation.

In the x-ray CAT example above, one can easily visualize the replacement of the x-ray beam with a terahertz laser beam and the x-ray detector replaced with a terahertz direct detection receiver, e.g., to form a direct detection terahertz computed tomography (CT) systems. The references cited above discuss in detail various implementation of direct detection terahertz computed tomography systems. The Wang article (Pulsed Terahertz Tomography) points out that the complex phase of the terahertz signal can be used to reconstruct the THz-computed tomography (CT) image in the same way as in the x-ray CT. This means that the same reconstruction algorithm can be used in THz-CT systems. In THz-CT, the reconstructed object function is the complex refractive index function of the object. Consequently properly constructed THz-CT systems can offer amplitude and phase variation information from the radiation transmitted through or back scattered from an object.

The same properties that make THz radiation attractive-namely the high absorption and emission from many gaseous species, liquids, and solids—make THz waves extremely difficult for obtaining significant penetration or propagation of THz radiation in the atmosphere and in many objects (e.g., especially if they have a H₂O content). This attenuation severally limits the use of THz radiation in imaging, radar, CAT, and communication applications. This is especially true for direct detection or time domain THz systems.

Researchers have recognized that a need exists for a THz transceiver system that has increased dynamic range and measurement capability over the direct detection systems. Specifically, a need exist for a THZ trans-receiver system that can detect weak THz signals through samples that have high loss. As pointed out in U.S. Patent Application Publication No. 2006/0016997 (the disclosures of which is incorporated by reference), continuous wave (CW) heterodyne imaging systems provide extremely large dynamic range and high signal-to-noise ratio advantages while maintaining fast data acquisition, stable magnitude and phase measurements, reasonable frequency flexibility and millimeter-scale penetration through wet tissues as well as other biological materials. In addition, heterodyning systems offer the capability of obtaining phase information from either the transmitted radiation propagated through the object or from the back scattered radiation from the object.

To date we are not aware of anyone that has conceived of a heterodyne THz computer aided tomography system to obtain superior sensitivity in obtaining internal images of objects. This is the subject of this patent disclosure.

### SUMMARY OF THE INVENTION

In one aspect, a method in accordance with the present invention for forming a three-dimensional internal image of an object, comprises illuminating the object with terahertz radiation and detecting, using a heterodyne receiver, terahertz radiation that is transmitted through the object, reflected from the object, or backscattered from the object. A series of two-dimensional images of the object at a plurality of different angles, or a plurality of different positions is recorded using the detected radiation. The two-dimensional images are electronically processing using computer aided tomography (CAT) algorithms to form the three-dimensional image of the object.

One embodiment of the present invention utilizes a THz transmitter and a RF frequency off-set THz laser local oscillator from the transmitter's output frequency to form a coherent (i.e., a heterodyne) detection computer aided tomography system for obtaining 3-D images of the interior of objects by detecting the amplitude variations of either the transmitted or the back scattered radiation. Another embodiment of the invention is to obtain tomographic images of an object by detecting amplitude and the phase changes of either the transmitted or the back scattered THz radiation. It would be advantageous to exploit the additional information that a 3-D imaging system would provide from such CAT THz systems in security examination of luggage, or packages for detecting concealed objects or substances such as explosives, drugs, biological agents, and the like. Such CAT THz systems would also be useful in imaging internal composition variations, such as defects, etc. within parts made from plastics, ceramics, concrete, composite materials, wood, paper, opaque glasses, etc. Since THz radiation is not an ionizing radiation, it does not have the potential to present health problems as would x-rays for such systems. It also will not damage biological samples. Consequently, THz CAT systems would have advantages over x-ray CAT systems.

### BRIEF DESCRIPTION OF THE DRAWINGS

FIG. 1 is a schematic diagram illustrating one embodiment of a terahertz heterodyne system employing computer aided tomography techniques for generating a three dimensional image of the interior of an object.

FIG. 2 is a schematic diagram similar to FIG. 1 except that the terahertz signal is derived from reflection rather than transmission.

FIG. 3 is a schematic diagram similar to FIG. 2 and including parabolic collecting optics.

FIG. 4 is a schematic diagram illustrating another embodiment of a terahertz heterodyne system capable of measuring both amplitude and phase and employing computer aided tomography techniques for generating a three dimensional image of the interior of an object based on both measurements.

FIG. 5 is a schematic diagram of the processing electronics used in the FIG. 4 embodiment.

FIG. 6 is a schematic diagram similar to FIG. 4 except that the terahertz signal is derived from reflection rather than transmission.

FIG. 7 is a schematic diagram illustrating a modification for improving the performance of the embodiments shown in FIGS. 4 and 6.

### DETAILED DESCRIPTION OF THE INVENTION

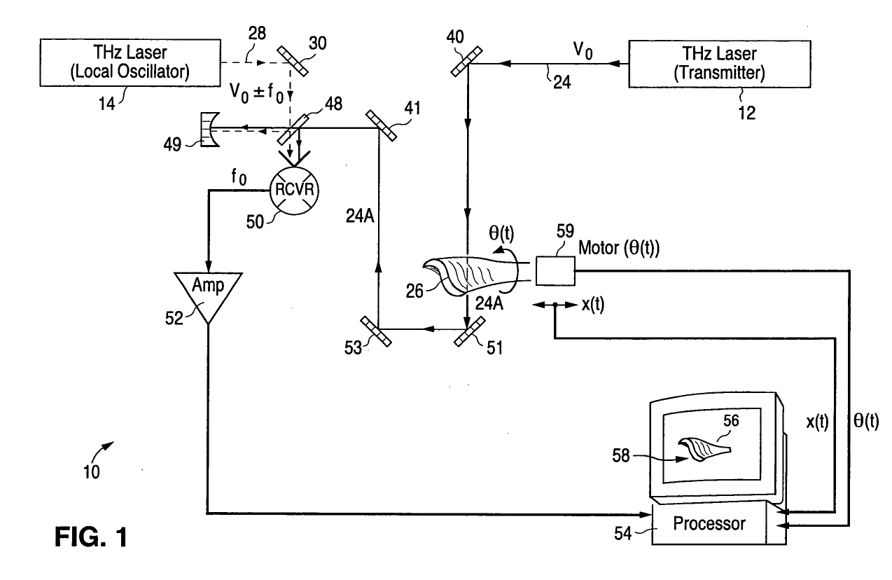

Referring now to the drawings, wherein like components are designated by like reference numerals, FIG. 1 schematically illustrates one preferred embodiment 10 of a heterodyne THz computer aided tomography imaging apparatus in accordance with the present invention. In FIG. 1, and in other drawings referred to herein below, the path of optical (THz) radiation is depicted by single-weight lines, either solid or dashed depending on frequency. The direction of propagation of the radiation is indicated by the open arrowheads. Electronic connections are depicted by double-weighted solid lines with the direction of electronic communication indicated, where appropriate, with a solid arrowhead.

Apparatus 10 includes two sources 12 and 14 of THz radiation. Here each of the sources is a THz-laser. One serves as a local oscillator 14 and the other as a transmitter 12. A preferred THz laser for the invention is an optically pumped THz-laser in which a gaseous gain-medium is pumped by radiation from a CO₂ laser. The output of the THz laser can be modulated (e.g., turned off and on) by modulating the output of the CO₂ pump laser by pulsing the RF power supply of the CO2 laser. This can conveniently be accomplished by turning the RF power supply energizing the CO₂ laser on and off. A THz-laser may have different nominal frequencies depending on the gaseous THz gain-medium contained within it. Any particular gain-medium has different discrete lasing frequencies about some nominal frequency characteristic of that gain-medium.

Accordingly, it is possible to select an output frequency ν₀ from many different THz frequencies between about 0.3 THz and 10.0 THz, by selecting a particular gain-medium and adjusting a diffraction grating within the THz resonator. Such CO₂ laser-pumped THz-lasers are commercially available. One such commercially-available THz-laser is a SIFIR-THz-laser available from Coherent Inc., of Santa Clara, Calif. This laser has excellent spatial mode quality and can emit between about 50 milliwatts (mW) and 100 mW of continuous wave (CW) power.

CO₂ laser-pumped THz lasers are preferred for CAT imaging applications, such as for apparatus 10 because of advantages including a wide range of available THz frequencies, relatively high power output, room temperature operations, and reliability. Those skilled in the art, however, know that in theory at least, other THz radiation sources both laser and electronic in nature may be used without departing from the spirit and scope of the present invention. By way of example, one possible electronic source of THz radiation is a backward-wave oscillator. Such an oscillator can emit up to 1.0 mW of CW power at (discrete) frequencies up to about 1.5 THz. THz backward-wave oscillators are at a less mature stage of development than optically pumped THz-lasers and may not be as reliable as commercially available THz-lasers.

Other possible THz-lasers include Quantum Cascade semiconductors lasers (QCL). These have an advantage of being relatively small by comparison with CO₂ laser-pumped THz lasers. Another advantage is that continuous tuning is possible over frequencies up to about 10 THz. QCL lasers, however, must be operated at cryogenic temperatures in order to achieve milliwatts of power output. For most applications, operation at cryogenic temperature is a serious disadvantage.

Another possible THz source is the use of tunable solid state lasers to drive a photomixer. Such a source can provide tunable radiation over the entire THz spectrum at room temperature operation range but with output power limited to tens of nanowatts.

Continuing with reference to FIG. 1, in apparatus 10, THz-radiation source 12 provides a beam 24 of radiation (the signal beam), having a frequency ν₀, which will be propagated through an object 26 to provide data for computing a series of strip integrals to obtain an image reconstruction from projection as is done in x-ray CAT to reconstruct a 3-D image of that object. The object 26, shown only as an example in FIG. 1, is an aerospace part constructed from composite materials (say a blade for either a jet engine or an aircraft's propeller, or a helicopter rotor blade). The disclosed THz CAT system would be useful in detecting delaminated layers within such composite structures. The occurrence of delaminated layers in such airborne structures would be highly dangerous to flight if not detected. Apparatus 10 is a heterodyne imaging system for which THZ-radiation source 14 functions as local oscillator (LO) and 12 functions as the transmitter. A beam 28 of radiation from THz-radiation source 14 is required to have a frequency that is offset from the frequency ν₀ of the signal beam 24 by a RF frequency f₀. Frequency f₀ is one preferred frequency of an electronic signal that contains data that will be electronically processed to provide a reconstructed 3-D image of the object being scanned by rotation and translation of the object and storing the variations of the THz radiation transmitted through the object.

For a frequency offset f₀ between about 0.5 MHz and 15 MHz, lasers 12 and 14 preferably have the same gain medium with laser 12 having an output frequency ν₀ near the peak of the gain curve and laser 14 electronically tuned to output radiation at a frequency ν₀+f₀ or ν₀−f₀ where these frequencies are frequencies of transitions of the gain medium adjacent the transition of peak gain. (Note, one can also get frequency offsets in the GHz region by using different laser lines for the transmitter and the local oscillator if this is desirable). This frequency offsetting method for gas lasers, and circuits therefore, are well known in the art and a detailed description thereof is not necessary for understanding principles of the present invention. A detailed description is included in U.S. Pat. No. 7,199,330, assigned to the assignee of the present invention, and the complete disclosure of which is hereby incorporated by reference.

The gain-medium of a THz laser typically consists of large, heavy gas molecules, for example, methanol (CH₃OH) or difluoromethane (CH₂F₂). Because of these heavy molecules there are many possible laser transitions for any gas, which can be spectrally very closely spaced. Accordingly, values for f₀ using this frequency offsetting method are typically in the above referenced MHz range. For larger values of f₀, say between about 500 MHz and 200 GHz, lasers 12 and 14 preferably have different gain-media.

Continuing with reference to FIG. 1, beam 24 of frequency ν₀ from laser 12 is redirected by mirror 40 to irradiate the desired object 26 of which a 3-D tomography image is desired. In the preferred arrangement of FIG. 1, the laser beam is passed through the object. The radiation 24A transmitted through the object is redirected by mirror 51, to mirror 53, to mirror 41 and to partly reflecting mirror 48. Mirror 48 redirects the laser radiation transmitted through the object onto the coherent detector (or receiver—RCVR) 50. The output beam 28 from the THz local oscillator 14 of frequency ν₀±f₀ is redirected to mirror 48 by mirror 30. Most of the beam 28 is reflected into the beam stop 49 by mirror 48 because only tens of milliwatts or less are needed from the local oscillator to perform the optimum heterodyne detection of beams 24. The high reflectivity (greater than ˜90%) of mirror 48 is desirable for redirecting most of the laser radiation 24A from the target onto the heterodyne detector 50.

Due to the heterodyne detection process caused by the mixing of part of the beam 28 and most of the beam 24A on the detector 50, the detector produces a RF signal f₀ which is amplified by amplifier 52 and fed to a processor 54 that contains the 3-D tomography image algorithms used to generate the desired image. The amplitude “A” of the signal f₀ (e.g., the IF frequency) varies with time “t” as the laser beam 24 moves over the object. A[f₀ (t, φ)] is detected and stored as the object is rotated and translated with time.

The object 26 is rotated as a function of time (Θ(t)) by a suitable motor 59. While the object is rotated, it is also move laterally as a function of time (x(t)) by a suitable motor not shown. This process is continued until the entire object is scanned. Information regarding Θ(t) and x(t) and the amplitude variation of the signal is provided to the data processor which stores the data and computes from the stored A[f₀(t,φ)], and x(t) signals the tomographic images by the use of 3-D tomography algorithms well known to those experienced in the art. See for example, Gabor T. Herman, Image Reconstruction from Projections, The Fundamentals of Computerized Tomography, Academic Press, Inc., Orlando Fla. (1980). The derivations found in the latter reference concentrate on X-Ray tomography and amplitude-only detection and images, but the equations derived are general enough to support the extension to fully-coherent (amplitude and phase data) imagery. Examples of THz CT image calculation techniques are also found in Pulsed Terahertz Tomography by S. Wang and X-C. Zhang, cited above.

The processor provides signals to an imaging system 58, displaying a tomographic image 56 of the object. The processor allows the image to be rotated on the display screen for detailed examination from numerous aspect angles by the viewer as in x-ray tomographic images.

The object 26 in FIG. 1 shown only as one example is a composite aerospace structure (i.e., a turbine engine, propeller, or helicopter blade, or other composite structure). Actually, it can be any object constructed from a material that will transmit a reasonably detectable amount of THz radiation. The high detection sensitivity of the heterodyne receiver approach disclosed allows the tomographic imaging of objects that have orders of magnitudes higher THz wave attenuation than is possible with direct detection THz systems. The object could be constructed from one or a combination of glass, ceramic, plastic, wood, paper, card-board, etc. type materials or of biological material.

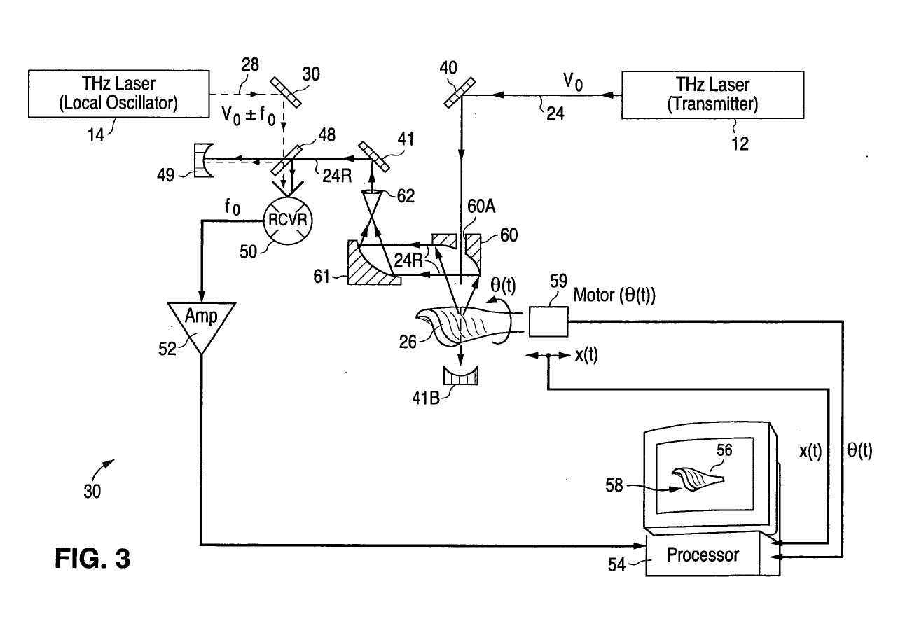

Improvements can be made to the basic system illustrated in FIG. 1 by adding more optical components in the 24 and 24A beam paths. For example, a focusing system can be added to focus the THz radiation within the object for increased resolution and for enhanced signal to noise. This change would also require moving the focal spot in the vertical direction Y(t) by moving the focusing lens to obtain a higher resolution image of a given plane within the object. Such an improvement would also require a wider angle radiation collection optical system to collect the radiation transmitted through the object and an additional optical system to re-collimate the radiation transmitted through the object to fill the surface of the detector 50. The addition of these optical components is well known to those experienced in the art. FIG. 3, discussed below, illustrates an example of these type of extra optics.

The THz detector 50 is preferably a Schottky-diode detector as schematically depicted in FIG. 1. Such detectors are commercially available, for example, from Virginia Diode, Inc., of Charlottesville, Va.

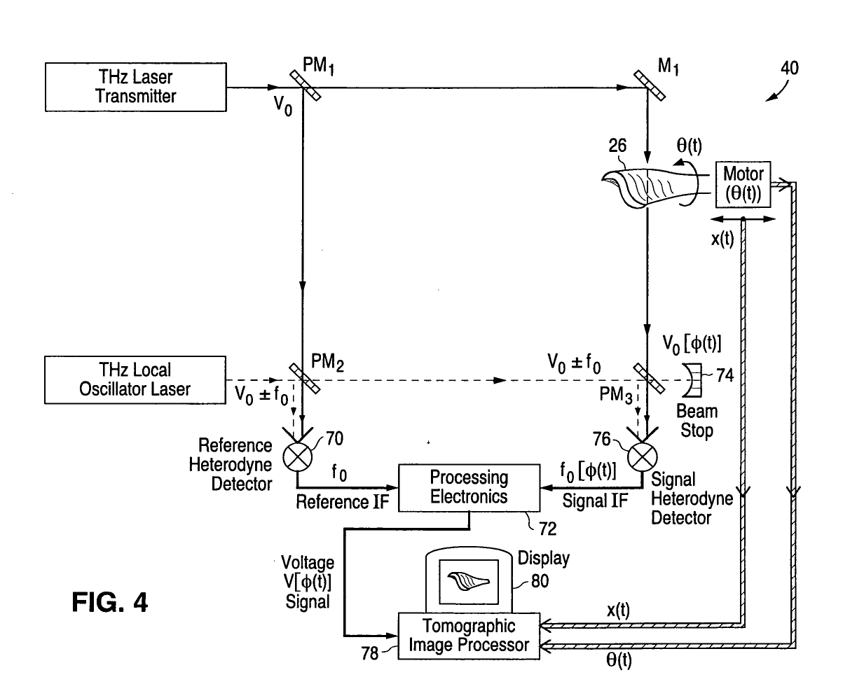

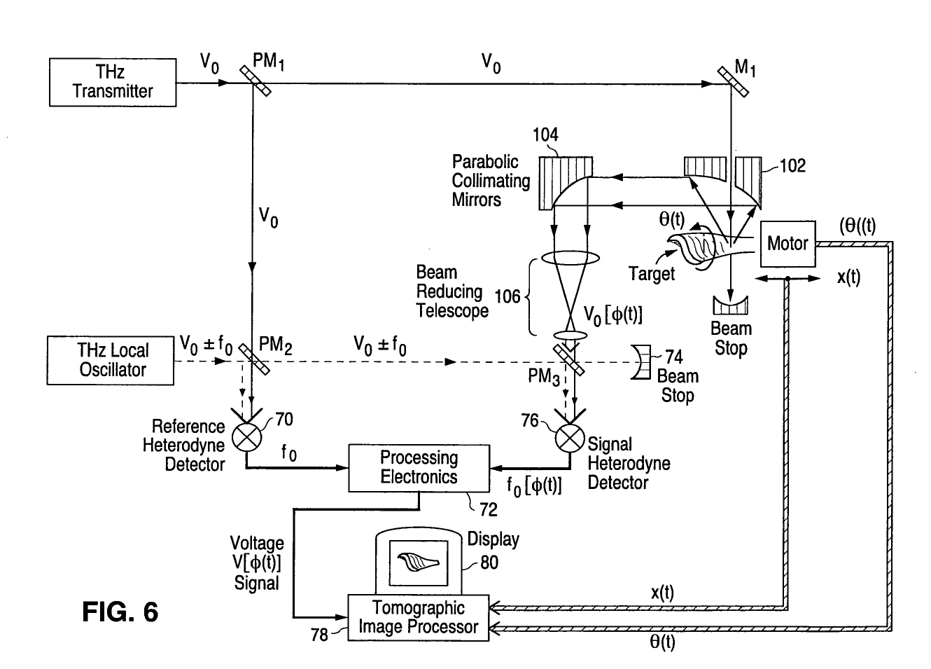

For a given power in beam 28, the transmission of beam splitter 48 for radiation having one of the frequencies ν₀_{_{—}}+f₀ is selected to allow sufficient power to be incident on detector 50 to optimize its heterodyne performance. The wave fronts of the portions of beams 24A and 28 incident on the detector are preferably aligned to be parallel. The diameter of the two beams portion are also preferably arranged to be equal. The beams of one of the selected frequencies ν₀±f₀ and ν₀ interfere in the detector to provide a signal having the offset RF frequency f₀. This signal varies in amplitude according to the instantaneous intensity of the transmitted beam 24A, through the object 26. The amplitude of this signal is dependent on the transmitted properties of the beam through the object and as a function of the motion Θ(t) and x(t) of the object. The phase of signal f₀ varies as the radiation passes though various portions of the object. The phase change occurs due to the changes in the distribution of the object's refractive index through which the beam propagates. In FIGS. 4 and 6, discussed below, systems are presented for also utilizing the phase change in f₀ as a function of x(t) and 0(t). This phase change information is processed by a processing electronics subsystem to obtain different image information then available from the amplitude variations information.

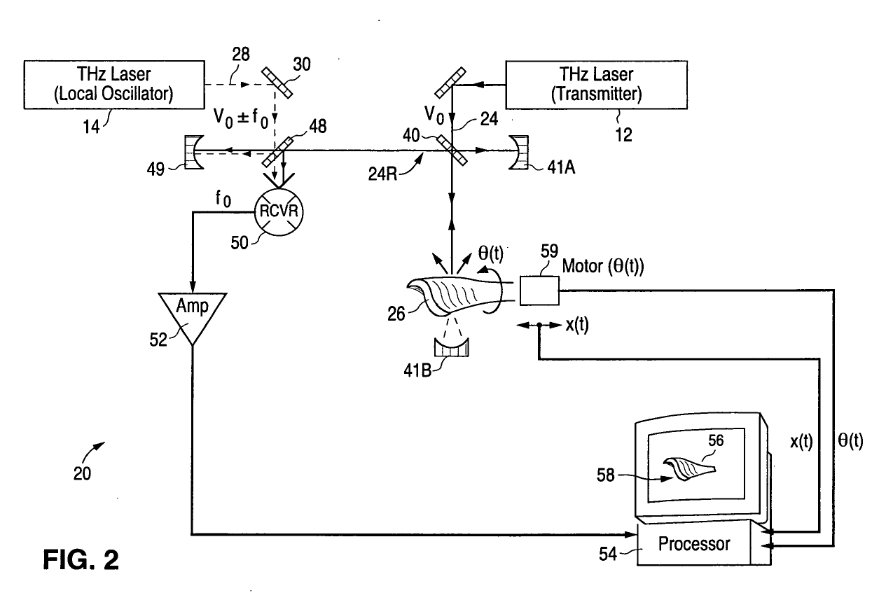

Another preferred embodiment of the 3-D THz tomography system using heterodyned detection is illustrated by FIG. 2. In the FIG. 2 system 20, the variations of the back scattered radiation from the object are detected as a function of the time varying parameters Θ(t) and x(t) instead of detecting the variation of the transmitted radiation through the object as shown in FIG. 1. A THz laser transmitter 12 and a local oscillator 14 are again utilized by the system 20 of FIG. 2. The transmitter laser beam 24 of frequency ν₀ is passed through a partially reflecting mirror 40 onto the object 26. Mirror 40 has ˜50% reflectivity so that fifty percent of the transmitter power is reflected into the radiation stop (e.g., radiation absorber) 41A, and the other fifty percent is propagated to the rotating and laterally translating object 26.

Back scattered radiation occurs from the non-uniformities residing within the object. The imaging of such non-uniformities within the object is a purpose of systems shown in herein. One half of the back scattered radiation 24R is reflected by mirror 40 toward the partially reflecting mirror 48. Mirror 48 typically has a reflectivity greater than ninety percent so that most of the back scattered radiation 24R reaches the RCVR heterodyne detector 50. As in FIG. 1, the output beam 28 of the laser local oscillator 14 having a frequency of ν₀±f₀, is redirected by mirror 30 to the partially reflecting mirror 48. Most of the local oscillator beam is reflected by mirror 48 into the radiation absorber 49.

The adjustment of mirrors 30 and 48 again allow for aligning the wave fronts of the combined radiation to be parallel when irradiating the detectors surface. The power of the local oscillator beam irradiating the detector is adjusted to optimize the detector's heterodyne performance.

The interference (i.e., mixing) of the radiation from beam 28 and back scattered radiation from beam 24R again cause an amplitude variation of the radiation from which the detector generates an RF frequency signal f₀ output. The amplitude of signal f₀ is dependent on the amount of radiation back-scattered from the target. Again as in the system of FIG. 1, the data processing of the amplitude or phase information will enhance image quality over non-heterodyned THz 3-D imaging system. One commonly used direct detection system utilizes ultra-short pulses from mode-locked lasers transmitters. The signal f₀ is again amplified by amplifier 52 and provided to a digital processor 54 as in system 10 of FIG. 1.

The radiation passing through the object is absorbed by the radiation stop 41B in the system 20 of FIG. 2.

The object is again rotated as a function of time by well known means (i.e., a variable speed motor 59) and a signal Θ(t) representing the motor's rotation with time is provided to the processor. In addition the object/rotating motor combination is moved laterally as a function of time by any one of numerous mechanical means not shown in FIG. 2. A signal representing this lateral motion with time x(t) is also provided to the processor as also described in FIG. 1. With the use of well known algorithms in the computer aided tomography state of the art, the process computes an image from the stored f₀(φ,t), Θ(t), and x(t) data streams.

Signal enhancement improvements can also be made to the basic back-scattering THz heterodyne 3-D tomography system 20 of FIG. 2 as stated for the system of FIG. 1. The system 30 of FIG. 3 illustrates one such possible improvement. It uses two parabolic mirrors for signal enhancement purposes. Parabolic mirror 60 has a small hole 60a to allow passage of the transmitter beam 24 onto the target as shown. Parabolic mirror 60 collects and collimates most of the back-scattered radiation 24R from the target and redirects the radiation to parabolic mirror 61. Mirror 61 brings the back scattered radiation 24R to a focus and lens 62 re-collimates the radiation 24R. Mirror 41 redirects the re-collimated beam 24R from lens 62 to the detector 50. The description for the rest of the system of FIG. 3 is identical as for FIG. 2 and will therefore not be repeated.

The heterodyne systems of FIGS. 1, 2, and 3 provide an image of the interior of an object by processing the amplitude variations of the radiation either transmitted through or back reflected from the object as a function of the angle of the object's rotation and of its translation. The variations in the phase of the THz radiation either transmitted through or back reflected from the object as it is rotated and translated can also provide imaging information of the interior of an object. Since the phase variations of the detected radiation depends on the changes in the velocity of propagation within the material distributed throughout the interior of the object, and not from the attenuation of the radiation by either absorption or reflection within the object, different details should be observed when the images obtained from either the amplitude variations in the attenuation of the transmitted beam or in the amplitude variation of the related beam are compared with the images obtained from detecting the phase change of either beam.

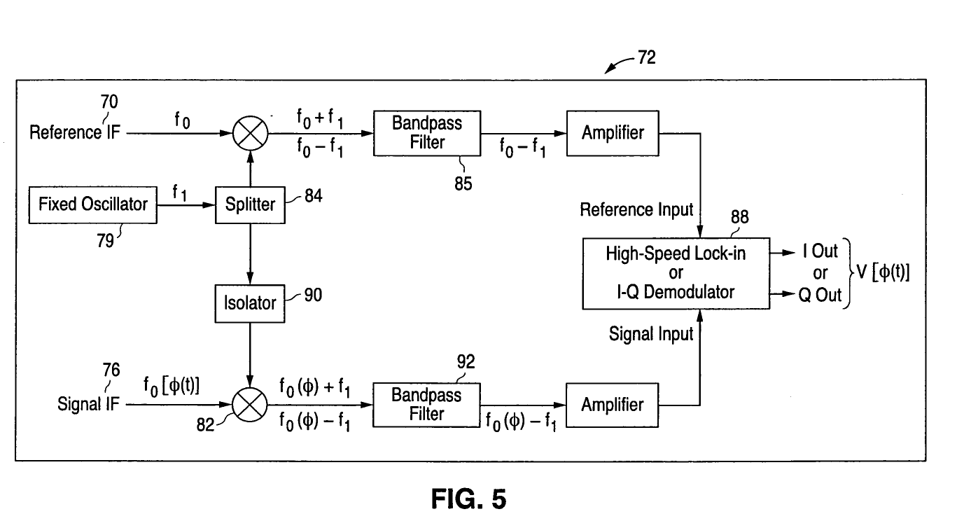

FIG. 4 illustrates a coherent detection THz tomography system 40 that senses both the phase and amplitude of the transmitted radiation through an object. It consists of a laser transmitter having a frequency ν₀ and a local oscillator having one of the frequencies ν₀±f₀. By means of partially reflecting mirrors PM₁ and PM₂, the transmitter and the superimposed local oscillator beams are made to illuminate the reference heterodyne detector 70 with their phase fronts parallel with each other. Angular adjustment of mirrors PM1 and PM2 are used to obtain the desired parallel phase fronts from the two beams. The transmitter beam is the solid line and the local oscillator beam is represented by the dashed line in FIG. 4. Under the described conditions the detector emits an RF signal f₀ as is well known in the state of the art. This reference RF signal f₀ is represented by the solid darker line in FIG. 4. The RF signal f₀ is fed to a processing electronics sub-system 72 which is shown in FIG. 5 and will be discussed later.

Partially reflecting mirror PM1 has a low reflectivity (say ≦10%), so most of the transmitter beam will impinge upon total reflecting mirror M1 and be directed to and through the object 26 to be examined. Partially reflecting mirror PM₂ also has low reflectivity (say ≦10%), so most of the local oscillator beam is propagated through PM₂ and directed to partially reflecting mirror PM₃. Mirror PM3 has a low reflectivity (again, say about ≦10%) so most of the local oscillating beam irradiating PM₃ is passed through to the beam stop 74. The remaining portion of the local oscillator beam is redirected to the signal heterodyne detector 76. Since PM₃ has a low reflectivity, most of the transmitter beam propagated through the object also illuminates the signal heterodyne detector 76. Again the phase fronts of the two beams illuminating the detector are made parallel to each other by adjustments to the positioning of mirrors M₁ and PM₃. The signal heterodyne detector 76 emits an RF signal f₀ resulting from the mixing of the two beams. The phase φ of this IF frequency signal differs from the fixed phase of the reference IF frequency f₀ because the phase of the beam propagated through the object is changed by the variations it encounters in the object's refractive index as the object is slowly rotated and then repeatedly stepped laterally to repeat the process until the entire object has been scanned. The time varying phase of the IF frequency, f₀[φ(t)], is also provided to the processing electronic subsystem 72. Subsystem 72 provides an electrical signal to the Tomographic Image Processor (TIP) subsystem 78 which utilizes well known algorithms to provide a tomographic image of the interior of the object by processing the electrical video signal and the time varying electrical signals θ(t) and x(t) produced by the sensors converting rotation (θ) and linear translation motion (x) of the object as a function of time (t), respectfully into electrical signals θ(t) and x(t). The rotation and translation electrical signals are denoted as cross-hatched heavy lines in FIG. 4.

The systems illustrated by FIGS. 1 through 4 illustrate only as an example, means of mechanically rotating and translating the object to obtain a tomographic image of the object. We believe these means to be more cost effective approach over other approaches, such as the use of scanning mirrors to scan the object and obtain the θ(t) and X(t) signals. The use of other means of illuminating the object as a function of time should not circumvent the basic of this invention which is to use heterodyne detection techniques to obtain tomographic images. Similarly, the use of various beam splitters to combine portions of the beams at the detectors 70 and 76 is merely for illustration only as there are many well know optical designs for combining radiation.

FIG. 5 provides some details of the processing electronic subsystem 72 of FIGS. 4 and 6. The subsystem 72 utilizes an RF oscillator 79 generating a convenient frequency f₁ which is split between two RF detectors 80, 82 by a RF splitter 84. The mixing of the f₁ signal with the reference IF signal f₀ of FIG. 4 produces upper (f₀+f₁) and lower (f₀−f₁) sideband signals. As an example, let us assume that we select f₀−f₁ to pass through the bandpass filter 85 while the filter is designed to stop the f₀+f₁ signal. The referenced f₀−f₁ signal is amplified and fed to either a high speed lock-in amplifier module or an in-phase quadrature demodulator module 88 discussed below.

The mixing of the other half of the f₁ signal is passed through an RF isolator 90 and illuminates detector 82. Detector 82 mixes the f₀[φ(t)]IF signal from the signal heterodyne detector of FIG. 4 with the f₁ fixed signal from oscillator 79 of to produce an upper f₀[φ(t)+f₁] lower RF side-bands f₀[φ(t)]−f₁. We will again assume, as an example, to select the lower side band signal f₀[φ(t)]−f₁ to pass through the band pass filter 92 while the filter is designed to stop the upper side band signal. This reference f₀[φ(t)]−f₁ signal is amplified and fed to either a high speed lock-in amplifier module or an in-phase quadrature demodulator module 88. These two modules are well known alternate electronic means of doing the same job which is to provide in-phase and quadrature (I and Q) voltage signals V[φ(t)] which can then be converted by the processor into amplitude and phase changes of the f₀[φ(t)] signal as a function of θ and x. The amplitude and phase changes information is then provided to the tomographic image processor (TIP) subsystem shown in FIG. 4 for display.

FIG. 6 illustrates a heterodyne detection THz tomography system that senses the phase of the back-reflected radiation from throughout the object. The system is essentially the same as the system of FIG. 4 except for the need for additional optics for collecting and recollimating the back scattered radiation. An inverse telescope lens arrangement is also needed to reduce the diameter of the signal beam to match the diameter of the referenced local oscillator beam before both beams illuminate the signal heterodyne detector. This is shown as an example in FIG. 6 with a pair of parabolic collimating mirrors 102 and 104 and a two lens beam reducing telescope 106. This arrangement is close to the same approach utilized in FIG. 3.

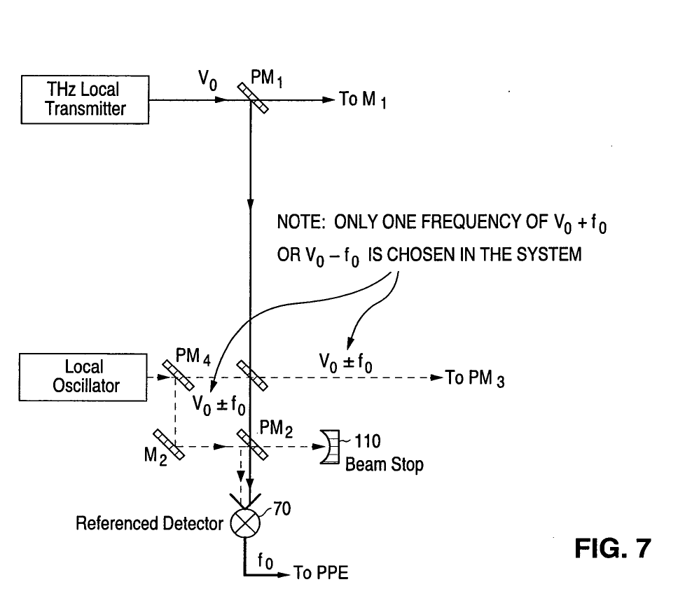

There is a difficulty with the simplified systems shown in FIGS. 4 and 6 that is easily corrected as per FIG. 7. The difficulty arises from the fact that the transmitter beam used to illuminate the reference heterodyne detector 70 is reflected from partially reflecting PM₂ and also redirected by PM₃ to illuminate the signal heterodyne detector 76. Consequently there are signals ν₀±f₀, ν₀[φ(t)] and ν₀ illuminating the signal detector 76 which is undesirable because signal ν₀ confuses the processing subsystem.

One preferred approach to solving this problem is to add another partially reflecting mirror PM₄, another totally reflecting mirror M₂ and a second beam stop 110 as illustrated in FIG. 7. This arrangement prevents the transmitter beam from reflecting off of PM₂ and being collimated with the local oscillator beam and both beams being directed toward PM₃ as occurred FIGS. 4 and 6. Partially reflecting mirror PM₄ is used to redirect the local oscillator beam to totally reflecting mirror M₂ and then to PM₂. The adjustment of these mirrors enable the superposition of the transmitter and local oscillator beams illuminating the reference detector 70 to have the parallel wave fronts required for efficient heterodyne detection.

Additional information can found in U.S. Patent Application Publication Nos. 2006/0214107 and 2007/0114418 as well as U.S. patent application Ser. No. 11/231,079, filed Sep. 20, 2005, the disclosures of which are incorporated by reference.

While the subject invention has been described with reference to the preferred embodiments, various changes and modifications could be made therein, by one skilled in the art, without varying from the scope and spirit of the subject invention as defined by the appended claims.

I claim:

1. A method of forming a three-dimensional internal image of an object, comprising the steps of:
illuminating the object with terahertz radiation;
detecting, using a heterodyne receiver, terahertz radiation that is one of transmitted through the object, reflected from the object or backscattered from the object;
recording a series of two-dimensional images of the object at one of a plurality of different angles, and a plurality of different positions, using the detected radiation; and
electronically processing the recorded two-dimensional images using CAT algorithms to form the three-dimensional image of the object.

2. The method of claim 1, wherein the recorded two-dimensional images include amplitude and phase information for the detected radiation.

3. The method of claim 1, wherein the detecting step includes detecting reference terahertz radiation having a frequency offset from the frequency of the terahertz radiation that illuminated the object.

4. An apparatus for generating a three dimensional image of the inside of an object comprising:
a first radiation source generating an inspection beam of terahertz radiation;
a second radiation source generating a reference beam of terahertz radiation having a frequency offset from the frequency of the inspection beam;
a scanning arrangement for directing the inspection beam to impinge upon the object at plurality of positions and from a plurality of directions;
collection optics for collecting the inspection beam after interaction with the object;
a signal detector for receiving the collected inspection beam and the reference beam and generating a heterodyned object signal with a difference frequency;
a processor for receiving the heterodyned object signal and, coupled with information from the scanning arrangement, generating three dimensional tomographic information; and
a display for displaying the tomographic information.

5. An apparatus as recited in claim 4, wherein said first and second radiation sources are optically pumped lasers in which a gaseous gain-medium is pumped by radiation from a carbon dioxide laser.

6. An apparatus as recited in claim 4, wherein said first and second radiation sources are defined by a backward wave oscillator.

7. An apparatus as recited in claim 4, wherein said first and second radiation sources are defined by a Quantum cascade laser.

8. An apparatus as recited in claim 4, wherein said first and second radiation sources are defined by a tunable sold state lasers driving a photomixer.

9. An apparatus as recited in claim 4, wherein the collection optics collect the inspection beam after transmission through the object.

10. An apparatus as recited in claim 4, wherein the collection optics collect the inspection beam after reflection from the object.

11. An apparatus as recited in claim 4, further including a reference detector for receiving a portion of the reference beam and a portion of the inspection beam prior to the inspection beam reaching the object, said reference detector generating a heterodyned reference signal with said difference frequency and wherein said processor uses the heterodyned object signal and the heterodyned reference signal to generate both amplitude and phase information which is used to generate the tomographic information.

12. A method for generating a three dimensional image of the inside of an object comprising:
generating an inspection beam of terahertz radiation;
generating a reference beam of terahertz radiation having a frequency offset from the frequency of the inspection beam;
scanning the inspection beam over the object from a plurality of different directions;
collecting the inspection beam after interaction with the object;
generating a heterodyned object signal with a difference frequency by detecting a portion of the collected inspection beam and a portion of the reference beam;
generating a heterodyned reference signal with said difference frequency by detecting a portion of the reference beam and a portion of the inspection beam prior to the inspection beam reaching the object;
generating amplitude and phase information based on the heterodyned object signal and the heterodyned reference signal;
generating three dimensional tomographic information based on the generated amplitude and phase information coupled with information about the position of the inspection beam during the scanning step; and
displaying the tomographic information.

13. A method as recited in claim 12, wherein the inspection and reference beams are generated by optically pumped lasers in which a gaseous gain-medium is pumped by radiation from a carbon dioxide laser.

14. An apparatus as recited in claim 12, wherein said first and second radiation sources are defined by a backward wave oscillator.

15. An apparatus as recited in claim 12, wherein said first and second radiation sources are defined by a Quantum cascade laser.

16. An apparatus as recited in claim 12, wherein said first and second radiation sources are defined by a tunable sold state lasers driving a photomixer.

17. A method as recited in claim 12, wherein the inspection beam is collected after transmission through the object.

18. A method as recited in claim 12, wherein the inspection beam is collected after reflection from the object.
